(19) United States
(12) Patent Application Publication
(10) Pub. No.: US 2003/0097308 A1
(43) Pub. Date: May 22, 2003

(54) Software evaluation tool

(76) Inventors: Mary Connors, Astoria, NY (US); Stephen Zailyk, Barrington, IL (US)

Correspondence Address: IP Department, Schnader Harrison Segal & Lewis, 36th Floor, 1600 Market Street, Philadelphia, PA, 19103, US

(21) Appl. No.: 09/998,570

(22) Filed: Nov. 16, 2001

(51) Int. Cl. G06F 17/60

(52) U.S. Cl. 705/26

(57) ABSTRACT

A system which fully automates the process of identifying and evaluating software products and software product vendors and for creating a request for proposal to send to the vendors. The system compares the business' requirements against a database of products and creates a list of the most appropriate products and ranks them according to how closely they match.

### BACKGROUND OF THE INVENTION

1. Field of the Invention

The present invention relates generally to online transactions and more particularly to a manner of identifying products and vendors.

2. Brief Description of the Prior Art

In businesses which employ software to automate their business processes, there is a need to research, compare, evaluate and select software in order to design and implement the automation process. Up until now, the research part of the process required the acquisition of large numbers of books, catalogs and spec sheets, a manual search of these materials for products which filled the needs of the job, and a manual comparison of the closest products to the job specifications. After the products were selected and their vendors were identified, requests for proposal to be sent to the vendors had to be manually prepared based upon the research and comparisons.

Accordingly, there is a need for a system which allows a business to efficiently, quickly, and accurately identify and evaluate software products and software product vendors for creating an automated system to create a request for proposal to send to the vendors based upon the automated identification and evaluation.

### SUMMARY OF THE INVENTION

The present invention discloses a system which fully automates the process of identifying and evaluating software products and software product vendors and for creating a request for proposal to send to the vendors. First, the user inputs the features of the software product that are required and the functions it must perform, after which the system creates a specification comprising the features and functions. The user then rates each feature and function and assigns weights to categories of features and/or functions. The system then prompts the business to rank each feature and function, ranks the products according to how closely they match the needs of the specification, generates a table of qualifying products and a list of vendors, and prepares a request for proposal to be emailed to the vendors of the products on the list.

### BRIEF DESCRIPTION OF THE DRAWINGS

FIG. 1 is a block diagram flow chart showing one embodiment of the flow of information in accordance with the present invention.

FIG. 2 is a block diagram flow chart showing one embodiment of the flow of information to create a spec.

FIGS. 3 and 3A are an embodiment of a screen display showing system environments and functionalities.

FIGS. 4, 4A, and 4B are an embodiment of a screen display showing the sequence of specifying functionalities and their degree of importance.

FIGS. 5, 5A, and 5B are an embodiment of a screen display showing subfunctionalities, how to select them, and to designate their importance.

### DETAILED DESCRIPTION OF THE PREFERRED EMBODIMENTS

The implementation of this invention requires the creation of a database in a computer system containing preferably detailed vendors' profiles from many software vendors within numerous application areas and covering thousands of features and functions.

A user must first determine that it has a need to purchase a software solution. Once such a determination is made, the user must evaluate the business environment, the functions and criteria that are required, and the nature of the user's software and system needs. Once these tasks are completed, the user may use the present embodiment to identify potential qualifying products and the vendors of those products, and to send requests for proposal to those vendors.

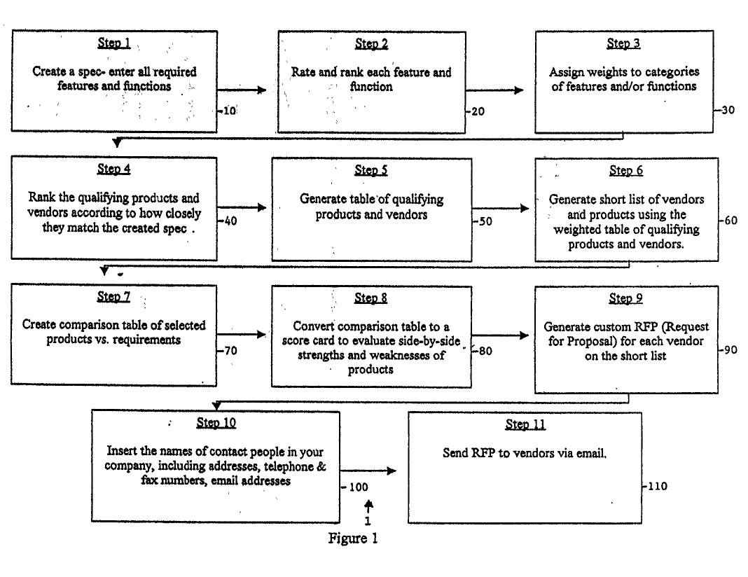

Referring now to FIG. 1 in detail, there is illustrated an embodiment of the computer system in accordance with the present invention. The terms “computer”, “computer system”, or “system” as used herein should be broadly construed to include any device capable of receiving, transmitting and/or using information including, without limitation, a processor, microprocessor or similar device, a personal computer, such as a laptop, palm PC, desktop or workstation, a network server, a mainframe, an electronic wired or wireless device, such as for example, a telephone, an interactive television, such as for example, a television adapted to be connected to the Internet or an electronic device adapted for use with a television, a cellular telephone, a personal digital assistant, an electronic pager, and a digital watch. In an illustrative example, information is transmitted in the form of e-mail. Further, a computer, computer system, or system of the invention may operate in communication with other systems over a network, such as, for example, the Internet, an intranet, or an extranet, or may operate as a stand-alone system. As will be described in detail herein, the system 1 provides a method and a system to identify qualifying software products, software product vendors, and to create a request for proposal to be sent to the vendors by email.

The database which is manipulated by a user business can be owned by a source business. The database includes information from a large number of vendors about the vendors' products. The information from each vendor includes a series of statements describing the functions its software can perform or which is can be adapted to perform. The vendor ranks each function or proposed function on a scale; for example, a scale of 1 to 4 in the present embodiment. A rank of 4 indicates that the function described is currently included in the standard version of the particular software product. A rank of 3 indicates that the vendor's software does not currently include the described function; but that the described function will be available as a standard version of the software product in the next version or release. A rank of 2 indicates that the described function is not currently available in a standard version of the software product; but that the function can be provided through a custom design and will cost more money than the vendor's standard version. A rank of 1 indicates that the described function is not offered by the vendor in the particular software described.

Before a user business can use the method of this embodiment, preferably it must access the database via a user ID and a password. Once the user business is in the database of the source business, it will follow the steps shown in FIG. 1.

As shown in block 10, Step 1 the user creates an online specification by entering all of the features and functions the user will require to be performed in the business process.

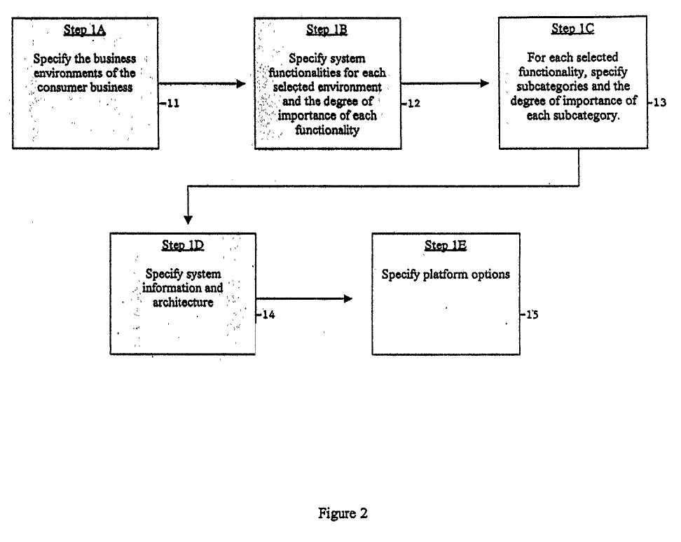

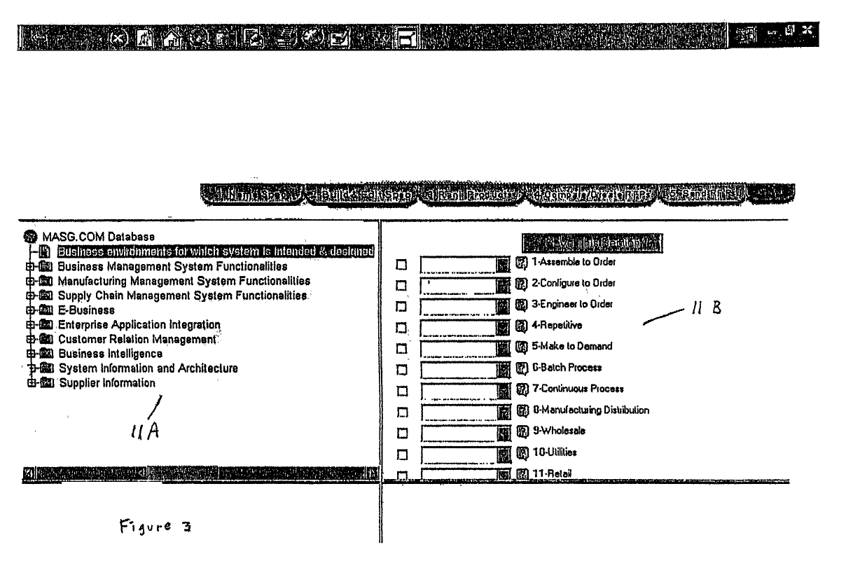

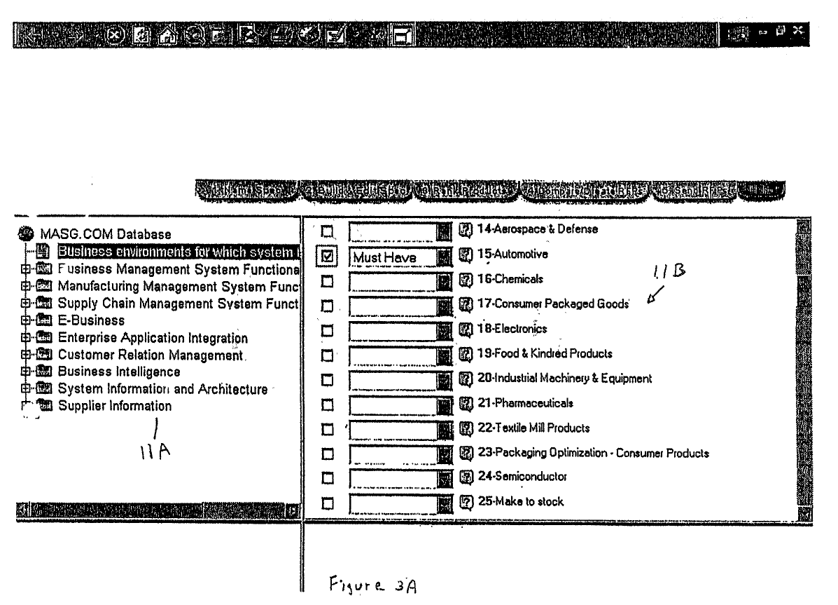

FIG. 2 is a flow chart which shows how the online specification is created. First, the consumer specifies its business environments as shown in FIG. 2, step 1A, block 11. An embodiment of the screen which allows the consumer to make these selections is shown in FIG. 3. FIG. 3 shows that the consumer has clicked on the heading entitled “business environments for which system is intended and designed” on the left side of screen 11A. Clicking on that heading causes the right side of the screen 11B to appear containing an embodiment of a list of environments. As illustrated in FIG. 3, the consumer can designate one or more of the environments as “must have” or another designation.

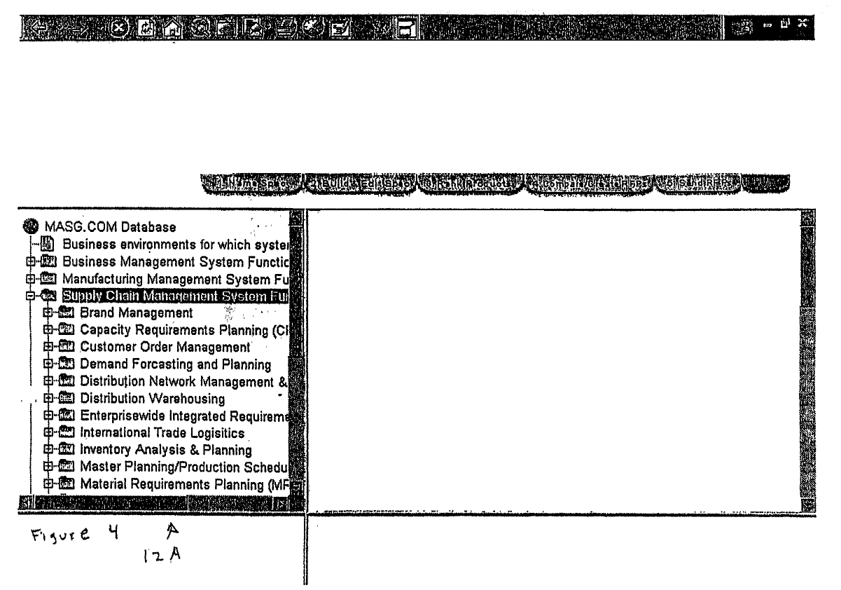

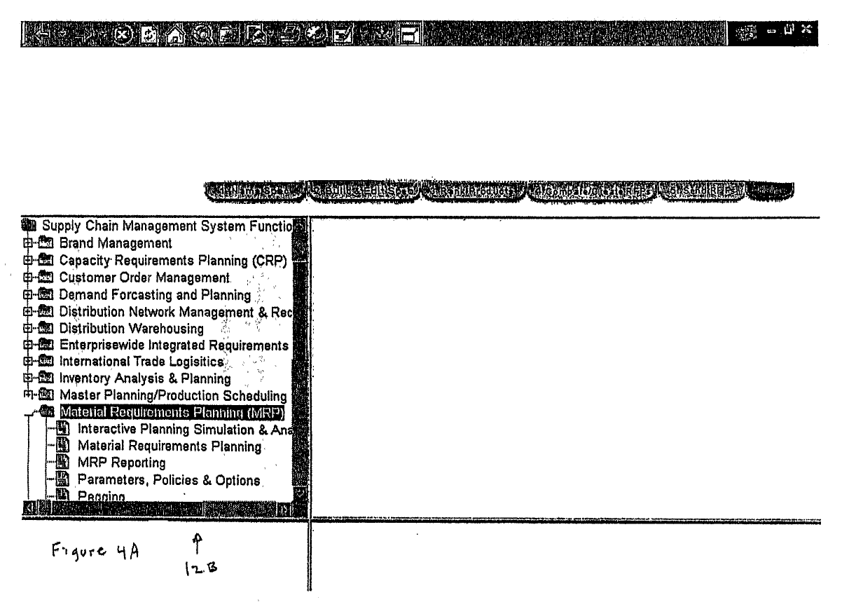

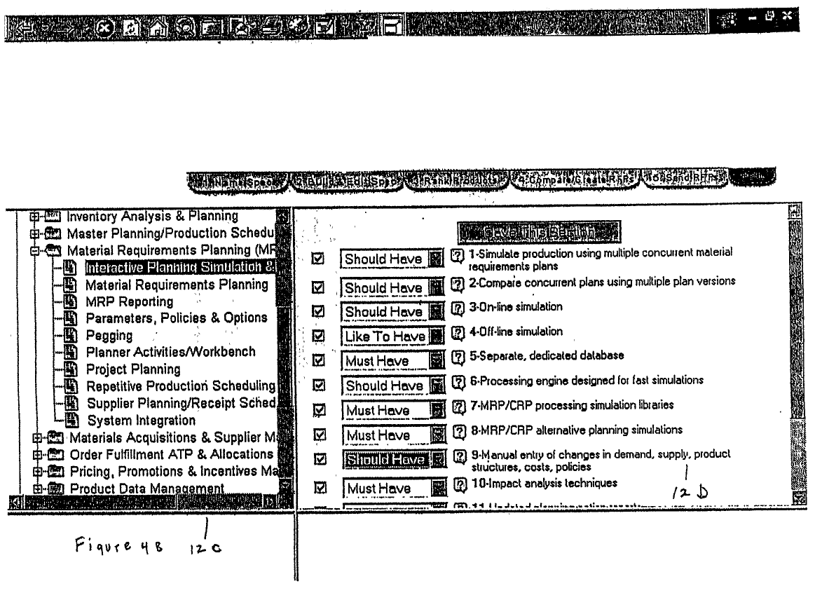

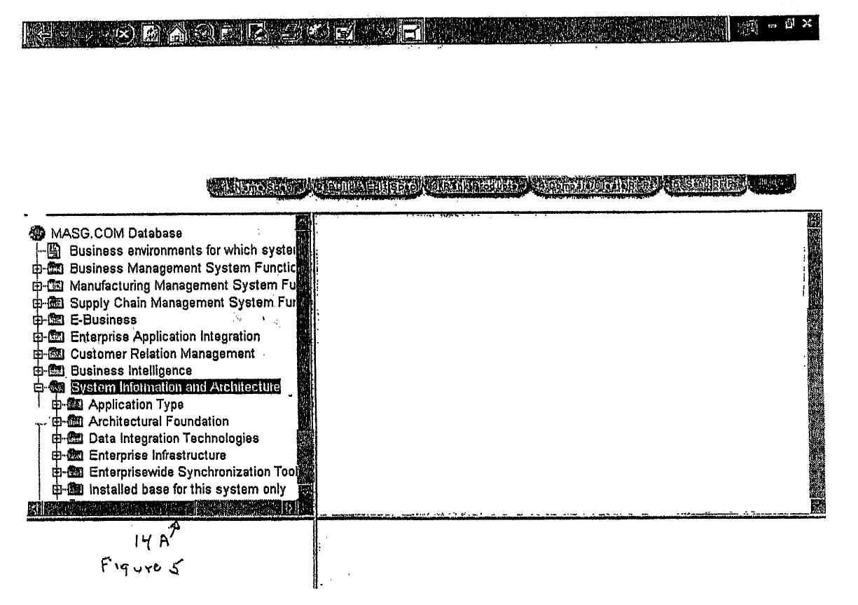

After the business environments are selected, the consumer specifies the system functionalities for each selected environment and the degree of importance of each functionality as shown in FIG. 2, block 12, step 1B. An embodiment of the sequence of specifying system of functionalities and their degree of importance is shown in FIGS. 4, 4A, and 4B. These figures show that the consumer has clicked on “supply chain management system functionalities” as shown by screen 12A and has selected “material requirements planning” as one of the supply chain management system functionalities as shown by screen 12B. When “material requirements planning” on screen 12B is selected, it shows a series of subfunctionalities, an embodiment of which is shown in FIG. 4B, screen 12C. As each subfunctionality is selected, the consumer is presented a screen which allows the consumer the opportunity to designate the degree of importance of each subfunctionality as shown on screen 12D in FIG. 4B. By using drop-down selections shown in FIG. 4B screen 12D, the consumer can designate the importance of each subfunctionality as something the consumer would “like to have,” “should have,” or “must have.”

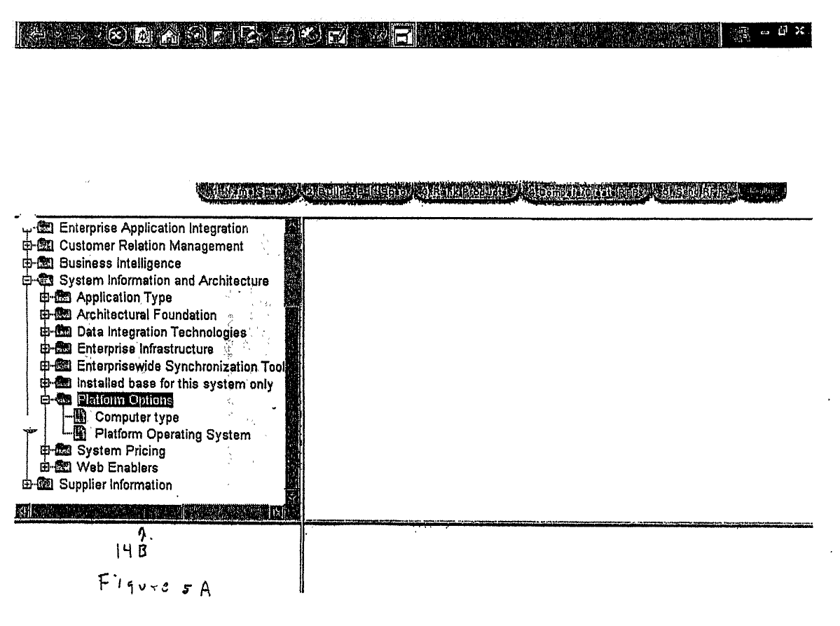

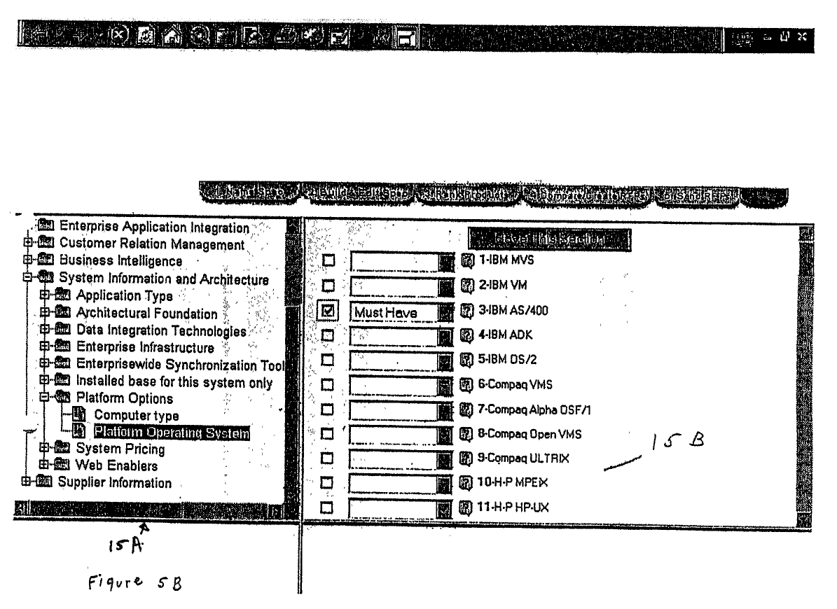

Referring to screen 11A in FIGS. 3 and 3A, the consumer can scroll down each applicable functionality. For example, screen 11A in FIG. 3 shows the System Information and Architecture functionality. This functionality is also shown as screen 14A in FIG. 5 and occurs as Step 1D in FIG. 2. An important subfunctionality of System Information and Architecture is performed in Step 1E and shown in screens 14B in FIG. 5A and in screens 15A and 15B in FIG. 5B. In this step, the consumer is able to specify the computer platform operating system.

After the specification is created online, Step 2, shown in block 20, allows the user to rate and rank each feature and function. For example, each feature can be ranked on a scale of 1 to 4 and each function can be ranked on a scale of 1 to 4, with 1 being the least necessary feature or function and 4 being the most needed feature or function. It will be understood by those skilled in the art that other equivalent ranking systems and nomenclatures can be used.

After rankings are assigned to each feature and function, block 30, depicting Step 3, shows that the user may assign weights to categories of features and/or functions. By using this weighting system, for example, platform could be weighted more importantly than application function. It will be understood by those skilled in the art that other categories of features and/or functions could also be weighted.

In Step 4, shown in block 40, the computer system then ranks the qualifying products in the database based upon the rating and ranking assigned to each feature and the weights given to each category of features and/or functions. Simultaneously, the computer system identifies the vendors of the products. Because of the aforesaid rating, ranking, and weighting, the Step 4 ranking is accomplished based upon how closely the products and vendors match the specification created in Step 1.

In Step 5, shown in block 50, the computer system then generates a table of the qualifying products and vendors identified in Step 4. Using the table generated in Step 5, Step 6, shown in block 60, allows the user to generate a short list of products and vendors from the table generated via Steps 4 and 5.

In Step 7, as shown in block 70, the computer system creates a table that compares the list of products generated in Step 6 with the requirements of the job identified in Step 1. In Step 8, shown in block 80, the comparison table is converted to a score card to evaluate the strengths and weaknesses of the selected products. This score card gives numerical scores, from 1 to 100, to each selected product depending on how close the product is to the needs identified in the specification. The table generated in Step 8 also shows the name of the vendor that sells each product.

Using the information identified in Step 8, the computer system prepares a Request for Proposal (RFP), shown in Step 9, block 90, for each vendor the user selects from the short list based upon the information shown in Step 8. Before the RFP is sent via email to the selected vendors, step 10, shown in block 100, is performed. In this step, the computer system is used to insert information about the requesting business such as the names of its contact people, including their addresses, telephone and fax numbers, and email addresses. The information added in Step 10 can also include the requesting business' deadlines for responses, a description of the overall project, as well as any other pertinent information. Finally, in Step 11, block 110, the RFP is sent via email to all of the selected vendors. The computer system generates a printout of the information sent, the date it was sent and to whom it was sent.

There are several advantages of the foregoing software evaluation tool.

For the business consumer these include:

1. The ability to quickly search preexisting databases for needed products.

2. The ability to rank product components in their order of importance.

3. The ability to quickly identify products which meets their needs.

4. The ability to simultaneously identify the vendors of each product.

5. The ability to quickly create a request for proposal to be sent to each vendor based upon the information which has already been entered into the computer system without the necessity of typing a second set of requirements.

6. The ability to send the request for proposal to each of the selected vendors.

For the vendors, these include:

1. The knowledge that the business consumer is a serious customer based upon the accuracy and detail of the RFP.

2. The precise products sought by the business consumer are readily identified.

3. An identification of the contact people at the business consumer.

4. Knowledge of the business' deadline.

It is understood, therefore, that the present invention is susceptible to many different variations and combinations and is not limited to the specific embodiments shown in this application. In addition, it should be understood that each of the elements disclosed all do not need to be provided in a single embodiment, but rather can be provided in any desired combination of elements where desired. It will also be appreciated that a system in accordance with the invention can be constructed in whole or in part from special purpose hardware or from conventional general purpose hardware or any combination thereof, any portion of which may be controlled by a suitable program. Any program may in whole or in part be comprised of or be stored on a system in a conventional manner, or remain whole or in part be comprised of or be stored on a system in a conventional manner, or remain whole or in part be provided into the system over a network or other mechanism for transferring information in a conventional manner. Accordingly, it is understood that the above description of the present invention is susceptible to considerable modifications, changes, and adaptations by those skilled in the art and that such modifications, changes and adaptations are intended to be considered within the scope of the present invention, which is set forth by the appended claims.

We claim:

1. A method for the identification and evaluation of software products and software product vendors and for creating a request for proposal to send to the vendors comprising the steps of:
a) identifying the features of the software product that are required and functions that it must perform;
b) creating a specification comprising said features and functions;
c) rating each feature and function;
d) ranking each feature and function;
e) assigning weights to categories of features and/or functions;
f) ranking software products according to how closely they match the features and functions in the created specification;
g) generating a table of qualifying products and vendors;
h) generating a short list of vendors and products using the weighted table of qualifying products and vendors;
i) creating a table comparing selected products with the requirements; and
j) comparing the specification with the qualifying products.

2. The method of claim 1, further comprising the steps of generating a custom request for proposal for vendors on the short list and sending the request for proposal to the vendors via email.

3. The method of claim 2 wherein the custom request for proposal is generated for all vendors on the short list and the request for proposal is sent to all vendors on the short list.

4. An interactive, computer-implemented system to identify and evaluate software products and software product vendors and to create a proposal to send to the vendors comprising a program of instructions executable by a computer to:
a) identify the features of the software product that are required and functions that it must perform;
b) create a specification comprising said features and functions;
c) rate each feature and function;
d) rank each feature and function;
e) assign weights to categories of features and/or functions;
f) rank software products according to how closely they match the features and functions in the created specification;
g) generate a table of qualifying products and vendors;
h) generate a short list of vendors and products using the weighted table of qualifying products and vendors;
i) create a table comparing selected products with the requirements; and
j) compare the specification with the qualifying products.

5. The system of claim 4 including means to generate a custom request for proposal for vendors on the short list and send the request for proposal to the vendors via email.

6. The method of claim 5 wherein the means to generate a custom request for proposal for vendors on the short list and for sending the request for proposal to the vendors includes email.

7. The method of claim 5 wherein the custom request for proposal is generated for all vendors on the short list and the request for proposal is sent to all vendors on the short list.

8. A computerized system to identify and evaluate software products and software product vendors and to create a proposal to send to the vendors comprising
a) devices to identify the features of the software product that are required and functions that it must perform;
b) devices to create a specification comprising said features and functions;
c) devices to rate each feature and function;
d) devices to rank each feature and function;
e) devices to assign weights to categories of features and/or functions;
f) devices to rank software products according to how closely they match the features and functions in the created specification;
g) devices to generate a table of qualifying products and vendors;
h) devices to generate a short list of vendors and products using the weighted table of qualifying products and vendors;
i) devices to create a table comparing selected products with the requirements; and
j) devices to compare the specification with the qualifying products.

9. The system of claim 8 including means to generate a custom request for proposal for vendors on the short list and send the request for proposal to the vendors via email.

10. The method of claim 8 wherein the means to generate a custom request for proposal for vendors on the short list and for sending the request for proposal to the vendors includes email.

11. The method of claim 8 wherein the custom request for proposal is generated for all vendors on the short list and the request for proposal is sent to all vendors on the short list.

12. An automated system for generating a custom request for proposal to be submitted to vendors of software comprising:
a) software to create a database of software products and software product vendors;
b) software to compare job specifications and requirements with said database;
c) software to generate a custom request for proposal based upon the comparison of the job specifications and requirements and database.

13. The automated system of claim 12 further comprising software to
a) identify the features of the software product that are required and functions that it must perform;
b) create a specification comprising said features and functions;
c) rate each feature and function;
d) rank each feature and function;
e) assign weights to categories of features and/or functions;
f) rank software products according to how closely they match the features and functions in the created specification;
g) generate a table of qualifying products and vendors;
h) generate a short list of vendors and products using the weighted table of qualifying products and vendors;
i) create a table comparing selected products with the requirements; and
j) compare the specification with the qualifying products.
